(19) United States
(12) Patent Application Publication
(10) Pub. No.: US 2019/0265716 A1
(43) Pub. Date: Aug. 29, 2019

(54) INFORMATION PROCESSING APPARATUS

(71) Applicant: NEC CORPORATION, Tokyo (JP)

(72) Inventor: Yasuyuki NASU, Tokyo (JP)

(73) Assignee: NEC CORPORATION, Tokyo (JP)

(21) Appl. No.: 16/282,717

(22) Filed: Feb. 22, 2019

(30) Foreign Application Priority Data
Feb. 26, 2018 (JP) 2018-031569

(51) Int. Cl. G05D 1/02; B60L 53/36; B60L 53/80; B60L 58/12; G05D 1/00

(52) U.S. Cl. CPC G05D 1/0225; B60L 53/36; G05D 1/0088; B60L 58/12; B60L 53/80

(57) ABSTRACT

An information processing apparatus of the present invention includes: an acquisition unit configured to acquire the status of a battery mounted on an electric vehicle; and a specifying unit configured to specify a battery replacement place at which the electric vehicle can arrive, on the basis of the status of the battery.

### INCORPORATION BY REFERENCE

This application is based upon and claims the benefit of priority from Japanese patent application No. 2018-031569, filed on Feb. 26, 2018, the disclosure of which is incorporated herein in its entirety by reference.

### TECHNICAL FIELD

The present invention relates to an information processing apparatus, a program, and an information processing method.

### BACKGROUND ART

In recent years, electric vehicles, such as electric cars, whose energy sources are electricity have prevailed. Such electric vehicles are, in addition to an electric vehicle traveling on general roads, a cart running on a predetermined site such as a golf course, a transporting vehicle for transporting baggage, a service vehicle carrying out a predetermined work while running, and so on. Some of these electric vehicles are operated by a person, and others travel autonomously.

The electric vehicle described above includes a battery that accumulates electricity, which is an energy source. When the remaining battery charge level of the battery of the electric vehicle decreases, the battery needs to be charged or replaced with a charged battery.

However, because the electric vehicle uses electric power as a power source for its own movement, the electric vehicle consumes a large amount of electric power. In addition to this, the capacity of the battery is still small and in the course of improvement. Therefore, it is important to be able to constantly grasp the place of a battery station where the battery can be charged or replaced and reach the battery station.

Patent Document 1 discloses a method for reserving battery replacement to a battery station by an electric vehicle. In this method, when the remaining battery charge level becomes equal to or less than a reference value, inquiry and reservation of battery replacement is made to a near battery station.
Patent Document 1: Japanese Unexamined Patent Application Publication No. JP-A 2014-003803

However, in the method according to Patent Document 1 described above, a problem of battery exhaustion occurs. The reason is that in the above method, reservation of battery replacement is made when the remaining battery charge level becomes equal to or less than the reference value and therefore there is a case where the remaining battery charge level is not sufficient for the electric vehicle to travel to the battery station where the reservation has been made. Moreover, such a problem of battery exhaustion may occur in any electric vehicle described above.

### SUMMARY OF THE INVENTION

Accordingly, an object of the present invention is to provide an information processing apparatus, a program, and an information processing method which enable solution of the problem described above, namely, occurrence of battery exhaustion in an electric vehicle.

An information processing apparatus as an aspect of the present invention includes:

an acquisition unit configured to acquire a status of a battery mounted on an electric vehicle; and

a specifying unit configured to specify a battery replacement place at which the electric vehicle can arrive, on a basis of the status of the battery.

Further, a non-transitory computer-readable medium storing a program as an aspect of the present invention includes instructions for causing an information processing apparatus to realize:

an acquisition unit configured to acquire a status of a battery mounted on an electric vehicle; and

a specifying unit configured to specify a battery replacement place at which the electric vehicle can arrive, on a basis of the status of the battery.

Further, an information processing method as an aspect of the present invention includes:

acquiring a status of a battery mounted on an electric vehicle; and

specifying a battery replacement place at which the electric vehicle can arrive, on a basis of the status of the battery.

According to the present invention with the configurations as described above, it is possible to inhibit occurrence of battery exhaustion in an electric vehicle.

### BRIEF DESCRIPTION OF DRAWINGS

FIG. 1 is a schematic diagram showing the overall configuration of an information processing system according to a first example embodiment of the present invention;

FIG. 2 is a block diagram showing the configuration of the information processing system disclosed in FIG. 1;

FIG. 3 is a sequence diagram showing the operation of the information processing system disclosed in FIG. 1;

FIG. 4 is a flowchart showing part of the operation of a management server disclosed in FIG. 1;

FIG. 5 is a schematic diagram showing the overall configuration of an information processing system according to a second example embodiment of the present invention;

FIG. 6 is a block diagram showing the configuration of the information processing system disclosed in FIG. 5;

FIG. 7 is a sequence diagram showing the operation of the information processing system disclosed in FIG. 5;

FIG. 8 is a flowchart showing part of the operation of a management server disclosed in FIG. 5; and

FIG. 9 is a block diagram showing the configuration of an information processing apparatus according to a third example embodiment of the present invention.

### EXAMPLE EMBODIMENT

### First Example Embodiment

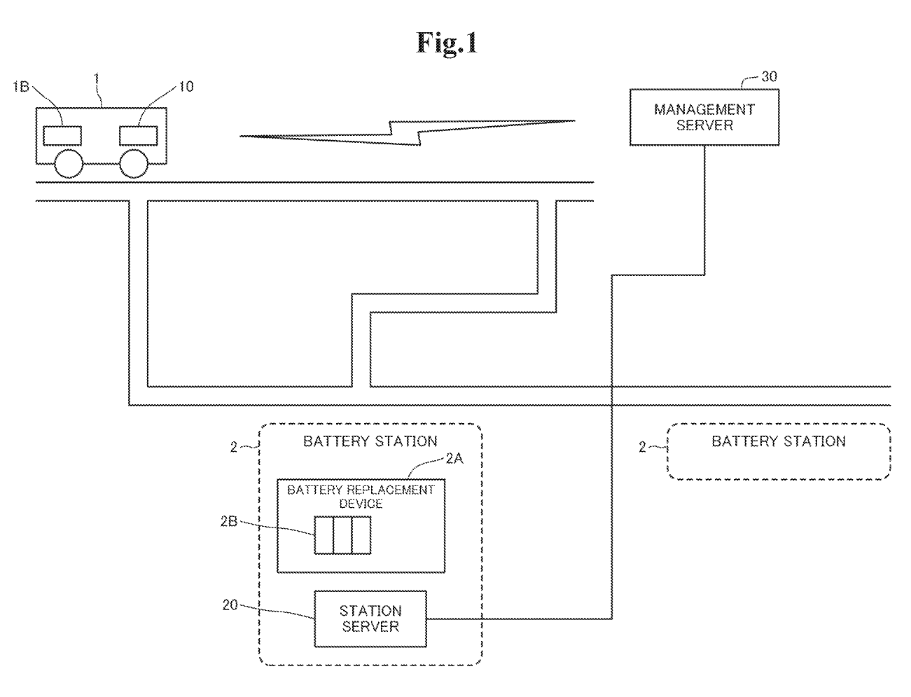

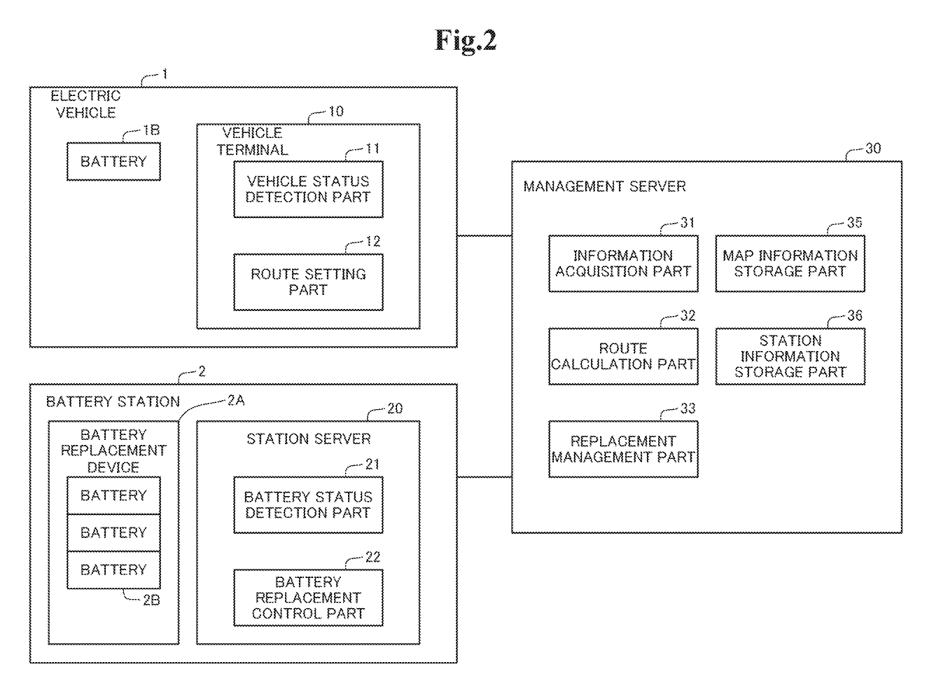

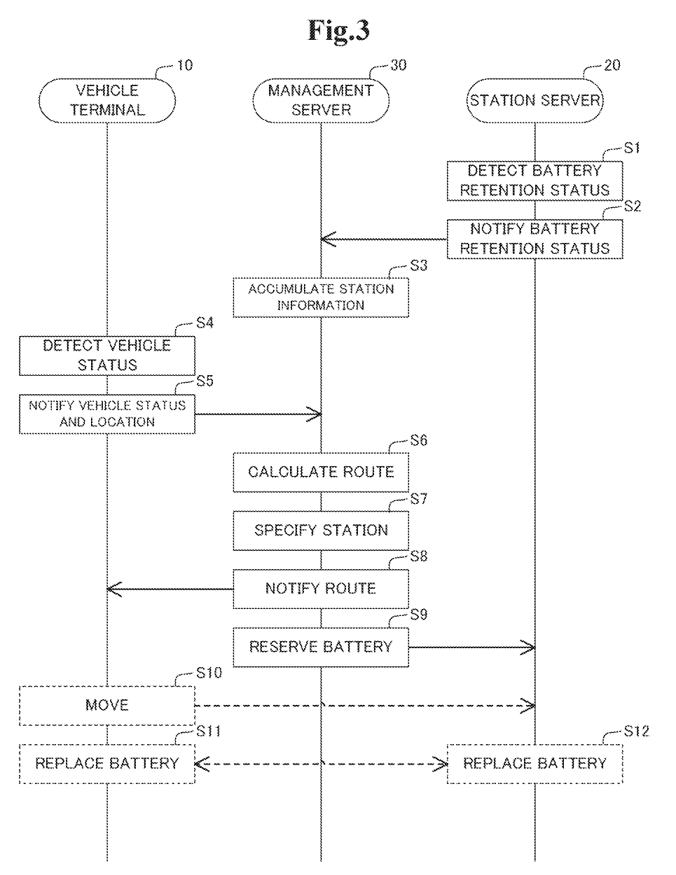

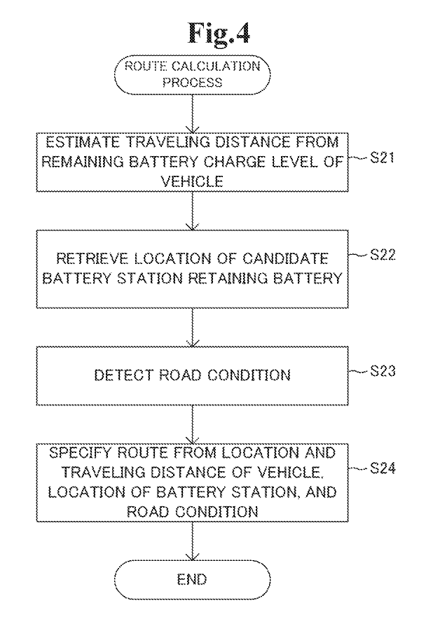

A first example embodiment of the present invention will be described with reference to FIGS. 1 to 4. FIGS. 1 and 2 are diagrams showing the configuration of an information processing system. FIGS. 3 and 4 are diagrams showing the operation of the information processing system.

### [Configuration]

The information processing system according to the present invention is to support replacement of a battery of an electric vehicle 1 whose energy source is electricity. As shown in FIG. 1, the information processing system includes a vehicle terminal 10 installed in the electric vehicle 1, a station server 20 installed in a battery station 2, and a management server 30. The vehicle terminal 10, the station server 20, and the management server 30 are connected via a network. Each component will be described in detail below.

In this example embodiment, it is assumed that the electric vehicle 1 is an autonomous vehicle that autonomously travels to carry packages or provide security at a predetermined place such as a factory, for example. Therefore, the electric vehicle 1 includes an autonomous traveling device (not shown). Note that the electric vehicle 1 may be an autonomous vehicle that travels on a preset route, or may be an autonomous vehicle that freely decides a traveling route and travels. However, the electric vehicle 1 of the present invention is not limited to being an autonomous vehicle, and may be a cart operated by a person and traveling on a predetermined site or an electric car traveling on general roads.

As shown in FIGS. 1 and 2, the electric vehicle 1 includes a battery 1B as a driving source. The battery 1B is chargeable, and the electric vehicle 1 is provided with a connector to which a charger is connected. Moreover, the battery 1B can be attached to and detached from the electric vehicle 1, and can be manually replaced or can be automatically replaced by a battery replacement device as described later. The number of the batteries 1B included in the electric vehicle 1 may be one or plural.

Further, the electric vehicle 1 includes the vehicle terminal 10 as shown in FIG. 2. The vehicle terminal 10 is an information processing terminal equipped with an arithmetic device and a storage device and is able to communicate with an external information processing apparatus by wireless communication. The vehicle terminal 10 includes a vehicle status detection part 11 and a route setting part 12, which are constructed by the arithmetic device executing a program.

The vehicle status detection part 11 (an acquisition unit) acquires vehicle status information (a vehicle status) representing the vehicle status of the electric vehicle 1 via various sensors installed in the electric vehicle 1. For example, the vehicle status detection part 11 acquires battery information such as remaining battery charge level information representing the remaining battery charge level of the onboard battery, battery deterioration information representing the deterioration status of the battery, and the type of the battery. The vehicle status detection part 11 may also acquire other information about the battery 1B as the battery information.

Further, the vehicle status detection part 11 may acquire information representing the status of anything other than the battery, such as the weight of the electric vehicle 1, the operation status of an air conditioner, the condition of equipment parts such as tires, as the vehicle status information. However, the vehicle status information acquired by the vehicle status detection part 11 is not limited to the information described above, and may be any information. Moreover, the vehicle status detection part 11 also detects current location information of the electric vehicle 1 as the vehicle status information.

The vehicle status detection part 11 notifies the management server 30 via the network of the vehicle status information including the battery information and the location information acquired as described above together with identification information of the electric vehicle 1. At this time, the vehicle status detection part 11 notifies the management server 30 of the vehicle status information including the battery information and the location information at a timing when the remaining battery charge level of the battery 1B becomes equal to or less than a preset threshold value, based on the acquired remaining battery charge level information. As an example, the threshold value of the remaining battery charge level is set to about a quarter of the full charge level. Consequently, at a timing when a distance that the electric vehicle 1 becomes short, the vehicle status detection part 11 notifies the management server 30 of the vehicle status information including the battery information as information for requesting battery replacement. At this time, in a case where the electric vehicle 1 includes a plurality of batteries 1B, the vehicle status detecting part 11 notifies the management server 30 at a timing when the remaining battery charge level of any one of the batteries 1B or the remaining battery charge level of all the batteries 1B becomes equal to or less than the threshold value. As with the management server 30 to be described later, the vehicle status detection part 11 may predict a travelable distance from the remaining battery charge level and, at a timing when the predicted distance becomes equal to or less than a preset threshold value, notify the management server 30 of vehicle information including the battery information. However, regardless of the remaining battery charge level information, the vehicle status detection part 11 may notify the management server 30 of the vehicle status information including the battery information and the location information at regular time intervals and may notify at any timing.

The route setting part 12 (a control unit), as will be described later, acquires route information representing a route to a battery station (a battery replacement place) as a destination transmitted from the management server 30. Then, the route setting part 12 sets the acquired route information to the onboard autonomous traveling device, and controls to autonomously travel according to the route information. In a case where the electric vehicle 1 is a vehicle which does not autonomously travel and is operated by a person to travel, the route setting part 12 performs processing to set the acquired route information to a navigation system or output the acquired route information to present to the driver.

The battery station 2 (the battery replacement place) is a place to replace the battery 1B of the electric vehicle 1 and is located at one place or a plurality of places. In this example embodiment, the battery station 2 replaces the battery of the electric vehicle 1, namely, detaches the battery whose battery charge level has become smaller from the electric vehicle 1 and installs another battery with a large charge amount stored, thereby replacing the battery of the electric vehicle 1. Therefore, the battery station 2 stocks the battery 2B to be replaced and mounted on the electric vehicle 1.

Further, as shown in FIG. 2, the battery station 2 includes a battery replacement device 2A that automatically replaces the battery for the electric vehicle 1. For example, the battery replacement device 2A includes and retains one or more batteries 2B stocked in the battery station 2 while charging the batteries 2B, and operates to detach the battery 1B mounted on the electric vehicle 1 stopped at a specified position of the battery station 2 and mount the retained battery 2B on the electric vehicle 1. However, the battery station 2 does not necessarily need to include the battery replacement device 2A for automatically replacing the battery, and the battery replacement may be conducted by the worker.

Note that the battery station 2 is not necessarily limited to replacing the battery for the electric vehicle 1, and may be provided with a charger for charging the battery mounted on the electric vehicle 1. As a result, the battery station 2 can connect the charger to the connector of the electric vehicle 1 and replace the battery 1B mounted on the electric vehicle 1 with its charge level.

Further, the battery station 2 includes the station server 20 as described above. The station server 20 is an information processing apparatus including an arithmetic device and a storage device, and can communicate with an external information processing apparatus via the network. As shown in FIG. 2, the station server 20 includes a battery status detection part 21 and a battery replacement control part 22, which are constructed by the arithmetic device executing a program.

The battery status detection part 21 is connected to the battery replacement device 2A and acquires the status of the battery 2B from the battery replacement device 2A. For example, the battery status detection part 21 acquires battery information such as the number, type, and charge level of the battery 2B installed in the battery replacement device 2A while being charged thereby. However, the battery status detection part 21 may acquire other information about the battery 2B installed in the battery replacement device 2A as the battery information.

The battery status detection part 21 notifies the management server 30 of battery retention information, which is information of the replaceable batteries 2B of the batteries 2B installed in the battery replacement device 2A, based on the acquired battery information. For example, the battery status detection part 21 notifies the management server 30 of the number and type of the batteries 2B with full charge level from the acquired battery information, as the battery information, together with identification information of the battery station 2. At this time, the battery status detection part 21 receives notification from the battery replacement control part 22 to be described later, and notifies the management server 30 while excluding information of the battery 2B that replacement with the battery 1B of any electric vehicle 1 has been reserved from the battery retention information. However, the battery status detection part 21 may notify the management server 30 of the reserved battery 2B together with information (a flag) representing reserved.

The battery status detection part 21 regularly acquires the battery information described above and notifies the management server 30 of the battery retention information. However, when there is some change in the battery information acquired at any timing, the battery status detection part 21 may notify the management server 30 of the battery retention information. Moreover, the battery status detection part 21 may receive the battery retention information, which is information of the battery 2B that is stored in the battery station 2 and can be replaced, input by an operator of the battery station 2 and notify the management server 30.

The battery replacement control part 22 (a control unit) receives the battery replacement information sent from the management server 30 as described later. The battery replacement information includes, for example, the identification information of the electric vehicle 1 scheduled to come to the battery station 2 and replace the battery later and the number and type of the battery 2B scheduled to be replaced with the battery of the electric vehicle 1. Then, the battery replacement control part 22 specifies the battery 2B scheduled to be replaced, and notifies the battery status detection part 21 that the battery 2B has been reserved.

Further, the battery replacement control part 22 controls the operation of the battery replacement device 2A so that the battery replacement device 2A replaces the battery of the electric vehicle 1 that is stopped at a designated position of the battery station 2. When an operator replaces the battery at the battery station 2, the battery replacement control part 22 may perform processing to notify the operator of the received battery replacement information.

The management server 30 (an information processing apparatus) is an information processing apparatus including an arithmetic device and a storage device, and is capable of communicating with an external information processing apparatus via the network. As shown in FIG. 2, the management server 30 includes an information acquisition part 31, a route calculation part 32, and a replacement management part 33, which are constructed by the arithmetic device executing a program. In addition, the management server 30 includes a map information storage part 35 and a station information storage part 36, which are formed in the storage device.

In the map information storage part 35, map information within a movement range of the electric vehicle 1 is stored. In particular, the map information includes information about roads on which the electric vehicle 1 can run. For example, road information included in the map information includes various road conditions such as the inclination and width of the roads, construction situations and congestion situations. Here, the road conditions may be a statistical value such as a congestion situation of a road measured in the past, or may be a current road condition measured at another place.

In the station information storage part 36, information of each battery station 2 is stored. The information of the battery station 2 includes location information of the battery station 2 in the map information and battery retention information of the battery station 2 obtained by the information acquisition part 31 to be described later.

Upon receiving the battery retention information sent regularly or at any timing from the station server 20, the information acquisition part 31 (an acquisition unit) updates the information of the battery station 2 in the station information storage part 36 and stores the information. Specifically, the information acquisition part 31 specifies the battery retention information in the station information storage part 36 corresponding to the identification information of the battery station 2 sent together with the battery retention information, and updates the battery retention information to the received information. As a result, in the station information storage part 36 of the management server 30, the latest information of the replaceable battery 2B installed in the battery station 2 is stored in association with the location information of each battery station 2.

Further, the information acquisition part 31 receives vehicle status information sent from the electric vehicle 1. At this time, because the electric vehicle 1 sends vehicle status information in a situation such as at a timing when the remaining battery charge level becomes equal to or less than a preset threshold value as described above, the information acquisition part 31 receives the vehicle status information as information for requesting replacement of the onboard battery 1B. Then, the information acquisition part 31 notifies the route calculation part 32 of the received identification information of the electric vehicle 1 and the received vehicle status information including the battery information and the location information.

Based on the vehicle status information received from the electric vehicle 1 as described above and the information of each battery station 2 stored in the station information storage part 36, the route calculation part 32 (a specifying unit) performs processing to specify the battery station 2 at which the electric vehicle 1 can arrive. To be specific, the route calculation part 32 first calculates a distance that the electric vehicle 1 can travel in the normal state, based on the remaining battery charge level information and battery deterioration information included in the vehicle status information received from the electric vehicle 1. For example, the route calculation part 32 calculates a distance that the electric vehicle 1 can travel from the actual remaining battery charge level based on correspondence information between a remaining battery charge level and a traveling distance set in advance, and additionally performs a process such as discounting a distance calculated in consideration of the deterioration condition of the battery, thereby calculating a travelable distance. Moreover, the route calculation part 32 calculates the travelable distance also based on the vehicle status information other than the battery information, such as the weight of the electric vehicle 1 and the operating condition of the air conditioner. For example, the route calculation part 32 performs a process such as discounting more travelable distance as the weight of the electric vehicle 1 is heavier or discounting the travelable distance in a situation where the air conditioner is operating.

Then, the route calculation part 32, with the use of the map information stored in the map information storage part 35, specifies a candidate of a battery station at which the electric vehicle 1 can arrive based on the calculated travelable distance and the current location information of the electric vehicle 1 and the location information of each battery station 2, and moreover, calculates a candidate route. At this time, when calculating a candidate route, the route calculation part 32 also considers the inclination and congestion status of a road on the route. For example, the route calculation part 32 determines to set the travelable distance short in a case where the road is uphill because the battery consumption is large, or determines to avoid the route in a case where the road is heavily congested and the distance is long, and calculates a candidate route. Besides, the route calculation part 32 may calculate a route candidate based on information such as a congestion status, a construction status, the width of the road, and the number of pedestrians.

Thus, the route calculation part 32 specifies one battery station 2 at which the electric vehicle 1 can arrive and also specifies one route from the current location of the electric vehicle 1 to the battery station 2. Then, the route calculation part 32 notifies the replacement management part 33 of the information about the specified battery station 2 and route. However, the route calculation part 32 may specify a plurality of battery stations 2 at which the electric vehicle 1 can arrive, and may specify a plurality of routes.

The replacement management part 33 (a control unit) notifies the electric vehicle 1 of the information about the battery station 2 and route specified in the above-described manner. At this time, the electric vehicle 1 sets the notified route information to the onboard autonomous traveling device so that the electric vehicle 1 travels autonomously. As a result, the replacement management part 33 notifies the electric vehicle 1 of the battery station 2 to become a destination place of traveling and the route information up to the battery station 2, so that the electric vehicle 1 is controlled to autonomously travel to the specified battery station 2. Meanwhile, in a case where the electric vehicle 1 is not an autonomous vehicle, the route information is merely notified to the electric vehicle 1, but the route information is set to the navigation system or outputted so as to be presented to the driver in the electric vehicle 1.

Further, the replacement management part 33 notifies the battery replacement information to the station server 20 of the specified battery station 2 at which the electric vehicle 1 can arrive. At this time, the replacement management part 33 notifies the station server 20 of the identification information of the electric vehicle 1 and the number and type of the battery 2B scheduled to be replaced with the battery of the electric vehicle 1 as the battery replacement information, and reserves the battery 2B for replacement at the battery station 2.

Each time vehicle status information is received from the electric vehicle 1, the information acquisition part 31, the route calculation part 32, and the replacement management part 33 of the management server 30 may perform the processing to specify the battery station 2 and specify the route described above. Moreover, each time information is acquired from the battery station 2, or each time the map information in the map information storage part 35 is updated, the information acquisition part 31, the route calculation part 32, and the replacement management part 33 may perform the processing to specify the battery station 2 and the route.

Further, the information acquisition part 31, the route calculation part 32, and the replacement management part 33 of the management server 30 described above may be installed in the vehicle terminal 10 mounted on the electric vehicle 1 or may be installed in the station server 20 placed in the battery station 2. That is, the above-described processing to specify the battery station 2 and specify the route may be performed by the vehicle terminal 10 or the station server 20.

### [Operation]

Next, the operation of the information processing system described above will be described mainly with reference to the sequence diagram of FIG. 3 and the flowchart of FIG. 4. The operation described below is merely an example, and the information processing system is not necessarily limited to operating as described below and each device may operate as described above.

First, the station server 20 regularly detects and acquires battery information such as the number, type, and charge level of the onboard batteries 2B charged by the battery replacement device 2A (step S1). Then, the station server 20 notifies the management server 30 of battery retention information, which is information on the replaceable battery 2B (step S2).

The management server 30 specifies the battery retention information in the station information storage part 36 corresponding to identification information of the battery station 2 received together with the battery retention information, and updates the battery retention information to the received information and stores it (step S3). As a result, in the management server 30, the latest information on the replaceable battery 2B stocked in the battery station 2 is stored.

Further, the electric vehicle 1 detects vehicle status information including battery information and location information by using various sensors mounted thereon at regular time intervals (step S4). When the remaining battery charge level becomes lower than a reference value, the electric vehicle 1 notifies the management server 30 of the detected vehicle status information and requests replacement of the battery (step S5).

Upon receiving the vehicle status information from the electric vehicle 1, the management server 30 first calculates a distance that the electric vehicle 1 can travel in a normal state, based on remaining battery charge level information and so on included in the received vehicle status information. With the use of map information, the management server 30 specifies candidates of a battery station at which the electric vehicle 1 can arrive based on the calculated distance that the electric vehicle 1 can travel, the current location information of the electric vehicle 1 and the location information of each battery station 2, and calculates route candidates (step S6). Moreover, the management server 30 specifies the battery station 2 that stocks a battery which can be replaced with that of the electric vehicle 1 from among the battery station candidates and the route candidates (step S7).

To be specific, the above-described processing to specify a battery station by the management server 30 is performed in the following manner as shown in the flowchart of FIG. 4. First, the management server 30 calculates a distance that the electric vehicle 1 can travel in the normal state, based on the remaining battery charge level information and the battery deterioration information that are included in the vehicle status information received from the electric vehicle 1 (step S21). At this time, the management server 30 calculates the travelable distance based on not only the remaining battery charge level but also the vehicle status information other than the battery information, such as the weight of the electric vehicle 1.

Then, the management server 30 retrieves location information of a battery station retaining the battery 2B replaceable with the battery of the electric vehicle 1 from the stored information of each battery station 2 (step S22). Moreover, the management server 30 also detects conditions of a road such as the inclination and congestion status of the road (step S23).

Then, with the use of the map information, the management server 30 calculates candidates of a battery station at which the electric vehicle 1 can arrive and candidates of a route up to the battery station 2 based on the calculated distance that the electric vehicle 1 can travel, the current location information of the electric vehicle 1 and the location information of each battery station 2. Besides, in consideration of the inclination, width, construction status, congestion status and so on of roads on the route, the management server 30 specifies the battery station 2 at which the electric vehicle 1 can arrive and specifies the route from the current location of the electric vehicle 1 to the battery station 2 (step S24).

Subsequently, the management server 30 notifies the electric vehicle 1 of information about the specified battery station 2 and route (step S8). At the same time, the management server 30 notifies the station server 20 of the identification information of the electric vehicle 1 whose battery is to be replaced and the number and type of the battery 2B to be replaced with the battery of the electric vehicle 1, and reserves replacement of the battery 2B (step S9).

After that, the electric vehicle 1 sets the information of the route to the battery station 2 notified by the management server 30 to the autonomous traveling device and moves to the battery station 2 by autonomous traveling (step S10). When reaching the battery station 2, the electric vehicle 1 stops at a designated position in the battery station 2 by an autonomous traveling function. Then, the battery replacement device 2A of the battery station 2 automatically replaces the battery of the electric vehicle 1 (steps S11 and S12).

As described above, according to the information processing system of this example embodiment, the battery station 2 at which the electric vehicle 1 can arrive is specified in consideration of the state of a battery such as the remaining battery charge level of the electric vehicle 1. Therefore, the electric vehicle 1 can arrive at the battery station 2 without running out of battery and can realize replenishment or replacement of the battery.

### Second Example Embodiment

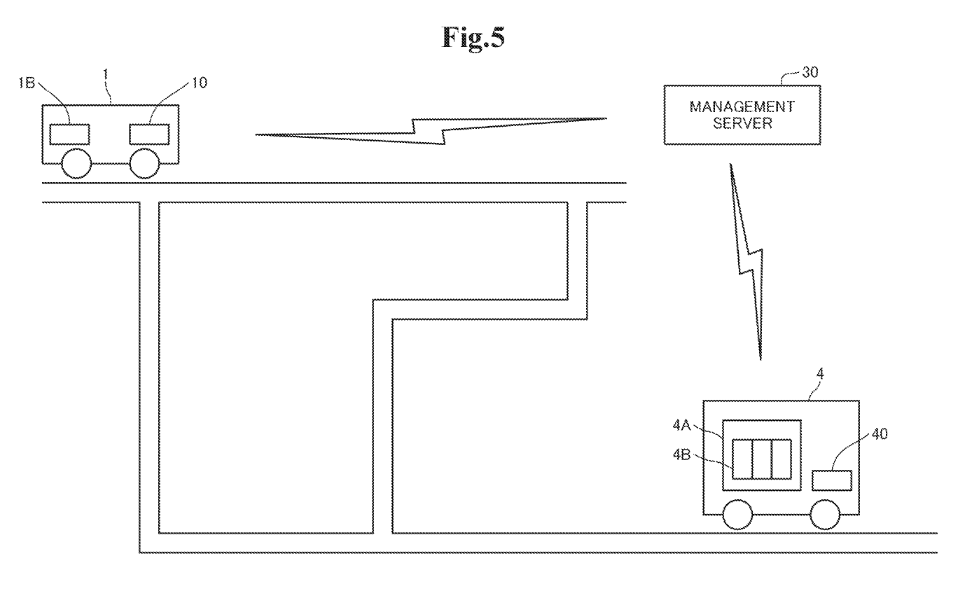

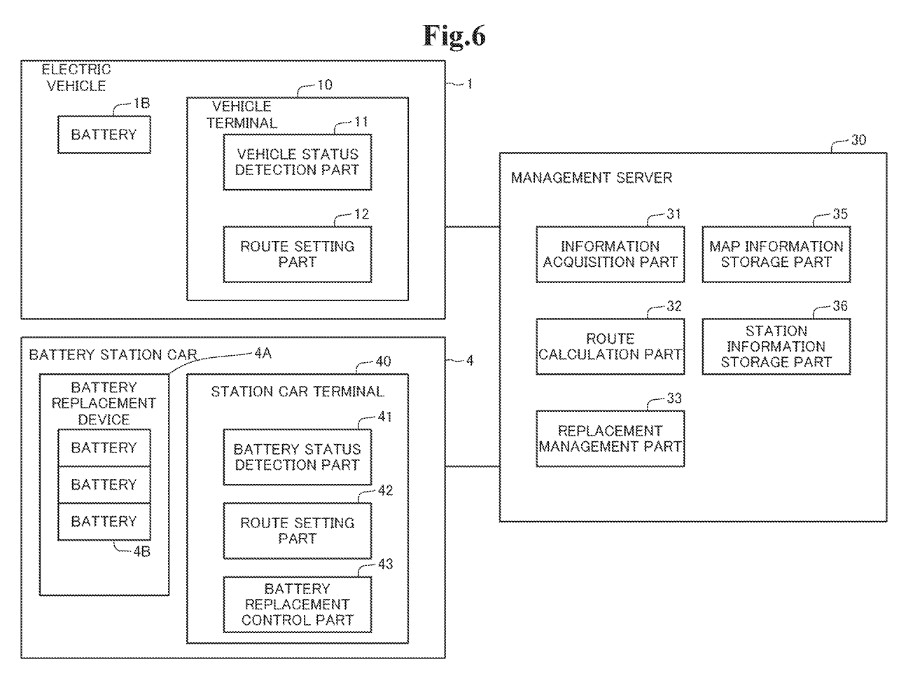

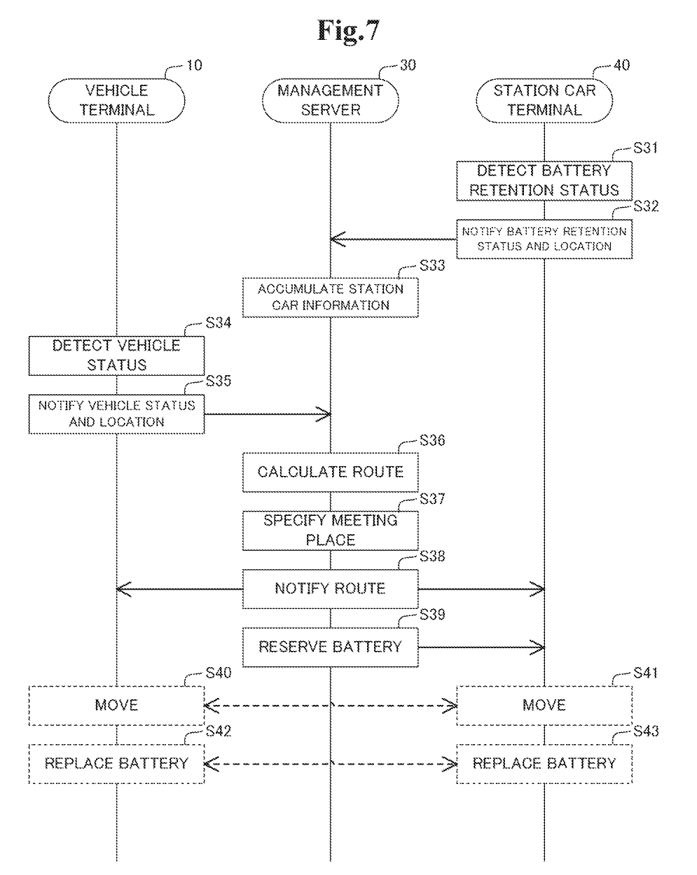

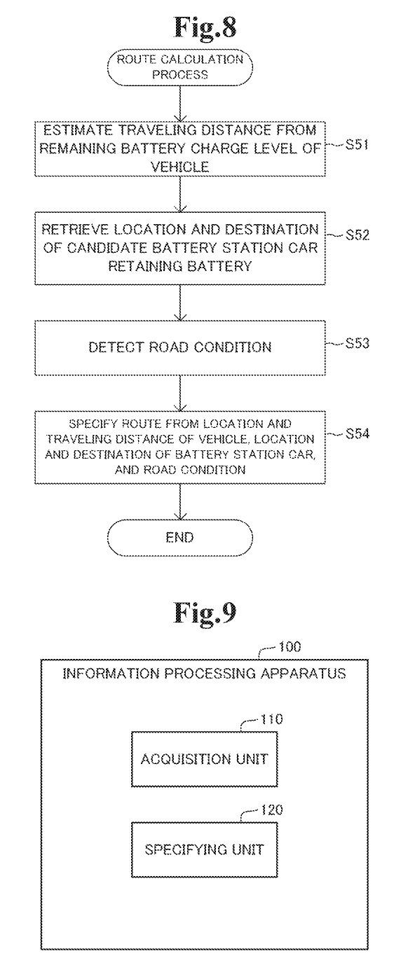

Next, a second example embodiment of the present invention will be described with reference to FIGS. 5 to 8. FIGS. 5 to 6 are diagrams showing the configuration of an information processing system. FIGS. 7 to 8 are diagrams showing the operation of the information processing system.

### [Configuration]

The information processing system according to the present invention is substantially the same in configuration as that of the above-described first example embodiment, but is different in that the battery station 2 described in the first example embodiment is configured by a battery station car 4 (a battery replacement place), which is a moving vehicle. Hereinafter, components that are different from those of the first example embodiment will mainly be described.

First, the electric vehicle 1 in this exemplary embodiment has almost the same configuration as that of the first example embodiment. Therefore, description of the configuration of the electric vehicle 1 will be omitted.

It is assumed that the battery station car 4 in this example embodiment is an autonomous vehicle that autonomously travels within a predetermined place such as a factory, for example. Therefore, the battery station car 4 includes an autonomous traveling device (not shown). However, the battery station car 4 is not limited to being an autonomous vehicle, and may be a vehicle which is operated by a person to travel.

The battery station car 4 has a function to replace the battery 1B of the electric vehicle 1, and one or more battery station cars are traveling. The battery station car 4 has the same configuration as the battery station 2 described in the first example embodiment. To be specific, as shown in FIGS. 5 to 6, the battery station car 4 stocks batteries 4B to be replaced and mounted on the electric vehicle 1. Moreover, the battery station car 4 includes a battery replacement device 4A that automatically replaces the battery for the electric vehicle 1. However, the battery station car 4 does not need to include the battery replacement device 4A that automatically replaces a battery, and the battery may be replaced by the operator.

Further, the battery station car 4 is equipped with a station car terminal 40 as shown in FIG. 6. The station car terminal 40 is an information processing terminal including an arithmetic device and a storage device and is able to communicate with an external information processing apparatus by wireless communication. The station car terminal 40 includes a battery status detection part 41, a route setting part 42, and a battery replacement control part 43, which are constructed by the arithmetic device executing a program.

The battery status detection part 41 is connected to the battery replacement device 4A and acquires the status of the battery 4B from the battery replacement device 4A. For example, the battery status detection part 41 acquires battery information such as the number, type, and charge level of the onboard batteries 4B charged by the battery replacement device 4A. However, the battery status detection part 41 may acquire other information about the batteries 4B included by the battery replacement device 4A as the battery information.

Based on the acquired battery information, the battery status detection part 41 notifies the management server 30 of battery retention information, which is information on the replaceable batteries 4B of the batteries 4B included by the battery replacement device 4A. For example, the battery status detection part 41 notifies the management server 30 of, as the battery retention information, the number and type of the fully charged batteries 4B from the acquired battery information. At this time, upon receiving notification from the battery replacement control part 43 to be described later, the battery status detection part 41 notifies the management server 30 of the battery retention information except the battery 4B for which replacement with the battery 1B of any electric vehicle 1 is reserved.

Further, the battery status detection part 41 detects current location information of the battery station car 4 and location information of a destination to which the battery station car 4 is scheduled to move. Then, the battery status detection part 41 notifies the management server 30 of the current location information and the movement destination location information.

The battery status detection part 41 regularly acquires the above-described battery information and location information and notifies the management server 30 of the battery retention information. However, the battery status detection part 41 may acquire the battery information, which is information of the replaceable batteries 4B stocked by the battery station car 4, upon receiving input by the operator of the battery station car 4.

The route setting part 42 (a control unit) acquires route information representing a route up to a place to meet the electric vehicle 1, sent by the management server 30 as described later. The route setting part 42 sets the acquired route information to an autonomous traveling device mounted thereon and controls so as to autonomously travel in accordance with the route information. In a case where the battery station car 4 is a vehicle which does not autonomously travel and is operated by a person to travel, the route setting part 42 performs a process such as setting the acquired route information to a navigation system and outputting so as to present to the driver.

The battery replacement control part 43 (the control unit) receives battery replacement information sent from the management server 30 as described later. The battery replacement information includes, for example, identification information of the electric vehicle 1 scheduled to come to the battery station car 4 to replace the battery later and the number and type of the battery 4B to be replaced with the battery of the electric vehicle 1. Then, the battery replacement control part 43 specifies the battery 4B to be replaced and notifies the battery status detection part 41 that the battery 4B is reserved.

Further, the battery replacement control part 43 controls the operation of the battery replacement device 4A so that the battery replacement device 4A replaces the battery of the electric vehicle 1 stopped at a designated position of the battery station car 4. In a case where an operator replaces the battery at the battery station car 4, the battery replacement control part 43 may perform processing to notify the operator of the received battery replacement information.

As shown in FIG. 6, the management server 30 (the information processing apparatus) in this example embodiment has almost the same configuration as in the first example embodiment, but is different in the following points.

First, when receiving the battery retention information regularly sent from the station car terminal 40, the information acquisition part 31 (the acquisition unit) updates information of the battery station car 4 in the station information storage part 36 and stores it. At this time, the information acquisition part 31 receives current location information of the battery station car 4 and location information of a movement destination together with the battery retention information, and stores into the station information storage part 36. As a result, in the station information storage part 36 of the management server 30, the latest information of the replaceable battery 4B stocked by each battery station car 4 is stored in association with the current location information of the battery station car 4 and the location information of the movement destination.

Further, in the same manner as in the first example embodiment, the information acquisition part 31 receives the vehicle status information sent from the electric vehicle 1. At this time, because the electric vehicle 1 sends the vehicle status information at a timing when the remaining battery charge level becomes equal to or less than a preset threshold value, the information acquisition part 31 receives the vehicle status information as information for requesting replacement of the onboard battery 4B.

Based on the vehicle status information received from the electric vehicle 1 in the above-described manner and the information of each battery station car 4 stored in the station information storage part 36, the route calculation part 32 (the specifying unit) performs processing to specify a place where the vehicle 1 and the battery station car 4 can meet. To be specific, in the same manner in the first example embodiment, the route calculation part 32 calculates a distance that the electric vehicle 1 can travel in the normal state, first based on the remaining battery charge level information and battery deterioration information included in the vehicle status information received from the electric vehicle 1 and further based on other vehicle status information.

Further, with the use of map information stored in the map information storage part 35, the route calculation part 32 specifies candidates of the place where the vehicle 1 and the battery station car 4 can meet based on the calculated travelable distance, the current location information of the electric vehicle 2, and the location information of the movement destination of each battery station car 4, and moreover calculates route candidates. Therefore, in this example embodiment, the meeting place may be specified so that the battery station car 4 approaches the current location of the electric vehicle 1, or the meeting place may be specified on the route up to the movement destination that is the destination of the battery station car 4.

As an example, in a case where the remaining battery charge level of the electric vehicle 1 is extremely small, the route calculation part 32 specifies the vicinity of the current location of the electric vehicle 1 as the meeting place. As another example, when a predetermined location on the route up to the movement destination of the battery station car 4 is close to the current location of the electric vehicle 1, the route calculation part 32 specifies the predetermined location on the route up to the movement destination of the battery station car 4, as the meeting place. Then, the route calculation part 32 specifies the route from the current location of the electric vehicle 1 to the specified meeting place and the route from the current location of the battery station car 4 to the specified meeting place, and notifies the specified routes to the replacement management part 33.

The replacement management part 33 (the control unit) notifies the electric vehicle 1 of the information about the route from the electric vehicle 1 to the merging place specified in the above-described manner. Moreover, the replacement management part 33 notifies the battery station car 4 of the information on the route from the battery station car 4 to the meeting place specified in the above-described manner. At this time, the electric vehicle 1 and the battery station car 4 each set the notified route information to the onboard autonomous traveling device and start autonomously travelling. Thus, the replacement management part 33 controls the electric vehicle 1 and the battery station car 4 so as to autonomously travel to the specified meeting place.

Further, the replacement management part 33 notifies the battery replacement information to the station car terminal 40 of the battery station car 4 that the electric vehicle 1 is scheduled to meet. At this time, the replacement management part 33 notifies the station car terminal 40 of, as the battery replacement information, the identification information of the electric vehicle 1 and the number and type of the battery 2B scheduled to be replaced for the electric vehicle 1, and reserves the battery 4B for replacement at the battery station car 4.

The information acquisition part 31, the route calculation part 32, and the replacement management part 33 of the management server 30 described above may perform the processing to specify the meeting place and specify the route described above every time receiving the vehicle status information from the electric vehicle 1. Moreover, the information acquisition part 31, the route calculation part 32, and the replacement management part 33 may perform the processing to specify the meeting place and the route each time information is acquired from the battery station car 4 or each time the map information in the map information storage part 35 is updated.

### [Operation]

Next, the operation of the above-described information processing system will be described mainly with reference to the sequence diagram of FIG. 7 and the flowchart of FIG. 8. It should be noted that the operation described below is merely an example, and the information processing system is not necessarily limited to operating in a manner described below, and each device may operate in the above-described manner.

First, the station car terminal 40 regularly detects and acquires battery information such as the number, type, and charge level of the onboard batteries 4B charged by the battery replacement device 4A (step S31). Then, the station car terminal 40 notifies the management server 30 of battery retention information that is information on the replaceable battery 4B, current location information, and location information of a movement destination to be a destination (step S32).

The management server 30 specifies information in the station information storage part 36 corresponding to the identification information of the battery station car 4 received together with the battery retention information, and updates the information to the received battery retention information and location information and stores (step S33). Consequently, in the management server 30, the latest information of the replaceable battery 4B stocked in the battery station car 4 and the latest information of the location are stored.

Further, the electric vehicle 1 detects vehicle status information including the battery information and the location information with the use of various sensors mounted thereon at constant time intervals (step S34). When the remaining battery charge level gets lower than a reference value, the electric vehicle 1 notifies the management server 30 of the detected vehicle status information (step S35).

Upon receiving the vehicle status information, the management server 30 first calculates a distance that the electric vehicle 1 can travel in the normal state, based on the remaining battery charge level information and so on included in the vehicle status information received from the electric vehicle 1. Then, with the use of the map information, the management server 30 calculates candidates of a meeting place where the electric vehicle 1 and the battery car station 4 can meet and route candidates, based on the calculated travelable distance and current location information of the electric vehicle 1 and location information of each battery station car 4 (step S36). Moreover, the management server 30 specifies the meeting place and the route from among the meeting place candidates and the route candidates in consideration of the distance, the battery retention condition of the battery station car 4, the condition of a road on the route, and so on (step S37).

To be specific, the above-described processing to specify the battery station by the management server 30 is performed in the following manner as shown in the flowchart of FIG. 8. First, the management server 30 calculates a distance that the electric vehicle 1 can travel in the normal state, based on the remaining battery charge level information and the battery deterioration information that are included in the vehicle status information received from the electric vehicle 1 (step S51). At this time, the management server 30 calculates the travelable distance based on not only the remaining battery charge level but also the vehicle status information other than the battery information, such as the weight of the electric vehicle 1.

Then, the management server 30 retrieves current location information of the battery station car 4 retaining the battery 4B that can be replaced for the electric vehicle 1 and location information of a movement destination, from the stored information of each battery station car 4 (step S52). Moreover, the management server 30 detects road conditions such as the inclination and congestion condition of the road on the route (step S53).

Then, with the use of the map information, the management server 30 calculates a meeting place and route that enable the electric vehicle 1 and the battery station car 4 to meet, from the calculated distance that the electric vehicle 1 can travel and the current location information of the electric vehicle 1 and the location information of each battery station car 4. Moreover, in consideration of the conditions of the road on the route, the management server 30 specifies a meeting place at which the electric vehicle 1 can arrive, and specifies a route from the electric vehicle 1 to the meeting place, and a route from the battery station car 4 to the meeting place (step S54).

Subsequently, the management server 30 notifies the electric vehicle 1 of the specified route from the electric vehicle 1 to the meeting place and the information of the battery station car 4 to meet (step S38). Moreover, the management server 30 notifies the battery station car 4 of the specified route from the battery station car 4 to the meeting place and the information of the electric vehicle 1 to meet (step S38). Besides, the management server 30 notifies the battery station car 4 of the number and type of the battery 4B to be replaced for the electric vehicle 1 and makes a reservation of replacement of the battery 4B (step S39).

After that, the electric vehicle 1 and the battery station car 4 each set the route information notified from the management server 30 to the autonomous traveling device and move to the meeting place by autonomous traveling (steps S40 and S41). Then, upon meeting the battery station car 4 at the meeting place, the electric vehicle 1 stops at a designated position of the battery station car 4 by the autonomous traveling function. Then, the battery replacement device 4A of the battery station car 4 automatically replaces the battery of the electric vehicle 1 (steps S42 and S43).

As described above, according to the information processing system in this example embodiment, in consideration of the battery status such as the remaining battery charge level of the electric vehicle 1, the battery station car 4 at which the electric vehicle 1 can arrive and the route are specified. Therefore, the electric vehicle 1 can reach the battery station car 4 without running out of battery, and it is possible to realize replenishment and replacement of the battery.

### Third Example Embodiment

Next, a third example embodiment of the present invention will be described with reference to FIG. 9. FIG. 9 is a block diagram showing the configuration of an information processing apparatus in the third example embodiment. In this example embodiment, the configuration of the information processing system described in the first and second example embodiments, specifically, the configuration of the management server 30 will be schematically shown.

As shown in FIG. 9, an information processing apparatus 100 in this example embodiment includes: an acquisition unit 110 configured to acquire the status of a battery mounted on an electric vehicle; and a specifying unit 120 configured to specify a battery replacement place at which the electric vehicle can arrive, on the basis of the status of the battery.

The acquisition unit 110 and the specifying unit 120 described above may be constructed by an arithmetic device executing a program, or may be constructed by an electronic circuit.

Then, the information processing apparatus 100 with the above configuration operates so as to perform a process of: acquiring the status of a battery mounted on an electric vehicle; and specifying a battery replacement place at which the electric vehicle can arrive, on the basis of the status of the battery.

According to the information processing apparatus 100 described above, the battery replacement place at which the electric vehicle can arrive is specified in consideration of the status of the battery such as the remaining battery change level of the electric vehicle. Therefore, the electric vehicle 1 can arrive at the battery replacement place without running out of battery, and it is possible to realize replenishment or replacement of the battery.

<Supplementary Notes>

The whole or part of the example embodiments disclosed above can be described as the following supplementary notes. Below, the configurations of an information processing apparatus, a program and an information processing method of the present invention will be described schematically. However, the present invention is not limited to the following configurations.

(Supplementary Note 1)

An information processing apparatus comprising:

an acquisition unit configured to acquire a status of a battery mounted on an electric vehicle; and

a specifying unit configured to specify a battery replacement place at which the electric vehicle can arrive, on a basis of the status of the battery.

(Supplementary Note 2)

The information processing apparatus according to Supplementary Note 1, wherein the specifying unit is configured to specify the battery replacement place at which the electric vehicle can arrive, on a basis of the status of the battery and on a basis of location information of the electric vehicle and location information of the battery replacement place.

(Supplementary Note 3)

The information processing apparatus according to Supplementary Note 2, wherein:

the acquisition unit is configured to acquire a remaining battery charge level of the battery; and

the specifying unit is configured to specify the battery replacement place at which the electric vehicle can arrive, on a basis of the remaining battery charge level of the battery and on a basis of a route between the electric vehicle and the battery replacement place based on the location information of the electric vehicle and the location information of the battery replacement place.

(Supplementary Note 4)

The information processing apparatus according to any of Supplementary Notes 1 to 3, wherein the specifying unit is configured to specify the battery replacement place at which the electric vehicle can arrive, on a basis of a condition of a route between the electric vehicle and the battery replacement place based on location information of the electric vehicle and location information of the battery replacement place.

(Supplementary Note 5)

The information processing apparatus according to any of Supplementary Notes 1 to 4, wherein:

the acquisition unit is configured to acquire a vehicle status representing a status of the electric vehicle other than the battery; and

the specifying unit is configured to specify the battery replacement place at which the electric vehicle can arrive, on a basis of the vehicle status and on a basis of a route between the electric vehicle and the battery replacement place based on location information of the electric vehicle and location information of the battery replacement place.

(Supplementary Note 6)

The information processing apparatus according to any of Supplementary Notes 1 to 5, wherein the specifying unit is configured to, in a case where the battery replacement place is configured by a moving vehicle, specify a location after movement of the battery replacement place at which the electric vehicle can arrive, on a basis of current location information of the electric vehicle and current location information of the battery replacement place.

(Supplementary Note 7)

The information processing apparatus according to any of Supplementary Notes 1 to 5, wherein the specifying unit is configured to, in a case where the battery replacement place is configured by a moving vehicle, specify the battery replacement place at which the electric vehicle can arrive, on a basis of current location information of the electric vehicle and location information of a movement destination to which the battery replacement place is scheduled to move.

(Supplementary Note 8)

The information processing apparatus according to any of Supplementary Notes 1 to 7, further comprising a control unit configured to, in a case where the electric vehicle has an autonomous traveling device, control the autonomous traveling device so that the electric vehicle autonomously travels to the specified battery replacement place.

(Supplementary Note 9)

A non-transitory computer-readable medium storing a program comprising instructions for causing an information processing apparatus to realize:

an acquisition unit configured to acquire a status of a battery mounted on an electric vehicle; and

a specifying unit configured to specify a battery replacement place at which the electric vehicle can arrive, on a basis of the status of the battery.

(Supplementary Note 10)

An information processing method comprising:

acquiring a status of a battery mounted on an electric vehicle; and

specifying a battery replacement place at which the electric vehicle can arrive, on a basis of the status of the battery.

(Supplementary Note 11)

The information processing method according to Supplementary Note 10, wherein the battery replacement place at which the electric vehicle can arrive is specified on a basis of the status of the battery and on a basis of location information of the electric vehicle and location information of the battery replacement place.

(Supplementary Note 12)

The information processing method according to Supplementary Note 11, wherein:

a remaining battery charge level of the battery is acquired; and

the battery replacement place at which the electric vehicle can arrive is acquired on a basis of the remaining battery charge level of the battery and on a basis of a route between the electric vehicle and the battery replacement place based on the location information of the electric vehicle and the location information of the battery replacement place.

(Supplementary Note 13)

The information processing method according to any of Supplementary Notes 10 to 12, wherein:

a vehicle status representing a status of the electric vehicle other than the battery is acquired; and

the battery replacement place at which the electric vehicle can arrive is specified on a basis of the vehicle status and on a basis of a route between the electric vehicle and the battery replacement place based on location information of the electric vehicle and location information of the battery replacement place.

(Supplementary Note 14)

The information processing method according to any of Supplementary Notes 10 to 13, wherein in a case where the battery replacement place is configured by a moving vehicle, a location after movement of the battery replacement place at which the electric vehicle can arrive is specified on a basis of current location information of the electric vehicle and current location information of the battery replacement place.

(Supplementary Note 15)

The information processing method according to any of Supplementary Notes 10 to 14, wherein in a case where the electric vehicle has an autonomous traveling device, the autonomous traveling device is controlled so that the electric vehicle autonomously travels to the specified battery replacement place.

The above-described program is stored in a storage device or recorded on a computer-readable recording medium. For example, the recording medium is a portable medium such as a flexible disk, an optical disk, a magneto-optical disk, and a semiconductor memory.

Although the present invention has been described above with reference to the example embodiments, the present invention is not limited to the example embodiments. The configurations and details of the present invention will be changed in various manners that can be understood by one skilled in the art within the scope of the present invention.

### EXPLANATION OF REFERENCE NUMERALS

1 electric vehicle
1B battery
10 vehicle status detection part
12 route setting part
2 battery station
2A battery replacement device
2B battery
20 station server
21 battery status detection part
22 battery replacement control part
30 management server
31 information acquisition part
32 route calculation part
33 replacement management part
35 map information storage part
36 station information storage part
4 battery station car
4A battery replacement device
4B battery
40 station car terminal
41 battery status detection part
42 route setting part
43 battery replacement control part
100 information processing apparatus
110 acquisition unit
120 specifying unit

1. An information processing apparatus comprising:
an acquisition unit configured to acquire a status of a battery mounted on an electric vehicle; and
a specifying unit configured to specify a battery replacement place at which the electric vehicle can arrive, on a basis of the status of the battery.

2. The information processing apparatus according to claim 1, wherein the specifying unit is configured to specify the battery replacement place at which the electric vehicle can arrive, on a basis of the status of the battery and on a basis of location information of the electric vehicle and location information of the battery replacement place.

3. The information processing apparatus according to claim 2, wherein:
the acquisition unit is configured to acquire a remaining battery charge level of the battery; and
the specifying unit is configured to specify the battery replacement place at which the electric vehicle can arrive, on a basis of the remaining battery charge level of the battery and on a basis of a route between the electric vehicle and the battery replacement place based on the location information of the electric vehicle and the location information of the battery replacement place.

4. The information processing apparatus according to claim 1, wherein the specifying unit is configured to specify the battery replacement place at which the electric vehicle can arrive, on a basis of a condition of a route between the electric vehicle and the battery replacement place based on location information of the electric vehicle and location information of the battery replacement place.

5. The information processing apparatus according to claim 1, wherein:
the acquisition unit is configured to acquire a vehicle status representing a status of the electric vehicle other than the battery; and
the specifying unit is configured to specify the battery replacement place at which the electric vehicle can arrive, on a basis of the vehicle status and on a basis of a route between the electric vehicle and the battery replacement place based on location information of the electric vehicle and location information of the battery replacement place.

6. The information processing apparatus according to claim 1, wherein the specifying unit is configured to, in a case where the battery replacement place is configured by a moving vehicle, specify a location after movement of the battery replacement place at which the electric vehicle can arrive, on a basis of current location information of the electric vehicle and current location information of the battery replacement place.

7. The information processing apparatus according to claim 1, wherein the specifying unit is configured to, in a case where the battery replacement place is configured by a moving vehicle, specify the battery replacement place at which the electric vehicle can arrive, on a basis of current location information of the electric vehicle and location information of a movement destination to which the battery replacement place is scheduled to move.

8. The information processing apparatus according to claim 1, further comprising a control unit configured to, in a case where the electric vehicle has an autonomous traveling device, control the autonomous traveling device so that the electric vehicle autonomously travels to the specified battery replacement place.

9. A non-transitory computer-readable medium storing a program comprising instructions for causing an information processing apparatus to realize:
an acquisition unit configured to acquire a status of a battery mounted on an electric vehicle; and
a specifying unit configured to specify a battery replacement place at which the electric vehicle can arrive, on a basis of the status of the battery.

10. An information processing method comprising:
acquiring a status of a battery mounted on an electric vehicle; and
specifying a battery replacement place at which the electric vehicle can arrive, on a basis of the status of the battery.

11. The information processing method according to claim 10, wherein the battery replacement place at which the electric vehicle can arrive is specified on a basis of the status of the battery and on a basis of location information of the electric vehicle and location information of the battery replacement place.

12. The information processing method according to claim 11, wherein:
a remaining battery charge level of the battery is acquired; and
the battery replacement place at which the electric vehicle can arrive is acquired on a basis of the remaining battery charge level of the battery and on a basis of a route between the electric vehicle and the battery replacement place based on the location information of the electric vehicle and the location information of the battery replacement place.

13. The information processing method according to claim 10, wherein:
a vehicle status representing a status of the electric vehicle other than the battery is acquired; and
the battery replacement place at which the electric vehicle can arrive is specified on a basis of the vehicle status and on a basis of a route between the electric vehicle and the battery replacement place based on location information of the electric vehicle and location information of the battery replacement place.

14. The information processing method according to claim 10, wherein in a case where the battery replacement place is configured by a moving vehicle, a location after movement of the battery replacement place at which the electric vehicle can arrive is specified on a basis of current location information of the electric vehicle and current location information of the battery replacement place.

15. The information processing method according to claim 10, wherein in a case where the electric vehicle has an autonomous traveling device, the autonomous traveling device is controlled so that the electric vehicle autonomously travels to the specified battery replacement place.
